(19) United States
(12) Patent Application Publication
(10) Pub. No.: US 2005/0138236 A1
(43) Pub. Date: Jun. 23, 2005

(54) Direct memory access control device and method for automatically updating data transmisson size from peripheral

(76) Inventors: In-Ki Hwang, Daejeon-city (KR); Dae-Hwan Hwang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/948,045

(22) Filed: Sep. 22, 2004

(30) Foreign Application Priority Data
Dec. 23, 2003 (KR) 10-2003-0095189

(51) Int. Cl. G06F 13/28

(52) U.S. Cl. 710/24

(57) ABSTRACT

A DMA controller includes a channel status generator determining whether the state of a channel connected to a peripheral corresponds to the first part of transmission data when receiving a DMA request from the peripheral; an address generator generating addresses of the peripheral and a memory; a control signal generator generating signals representing DMA operation states; and a buffer temporarily storing data from the peripheral and transmitting them to the memory. The address generator generates an address of a register storing a data transmission size of the peripheral when the channel state represents the first part of the data. The control signal generator generates a control signal for receiving a value stored in the register storing the data transmission size.

### CROSS REFERENCE TO RELATED APPLICATION

This application claims priority to and the benefit of Korea Patent Application No. 2003-95189 filed on Dec. 23, 2003 in the Korean Intellectual Property Office, the content of which is incorporated herein by reference.

### BACKGROUND OF THE INVENTION

(a) Field of the Invention

The present invention relates to a memory access control device and method. More specifically, the present invention relates to a direct memory access control device and method for automatically updating a data transmission size from a peripheral.

(b) Description of the Related Art

With the development of applications that require a large quantity of data such as video data, and a rapid data processing speed, a direct memory access (DMA) controller becomes increasingly important. The direct memory access controller (DMAC) is a device capable of processing a large quantity of data within a short period of time.

When a peripheral generates a DMA request in a conventional DMA system, the peripheral should generate a separate signal with respect to a data transmission size to transmit the signal to a processor and the processor should transfer the signal to a DMAC. This increases a period of time required for the DMA operation and the number of signals required, to result in deterioration in the system efficiency.

### SUMMARY OF THE INVENTION

It is an advantage of the present invention to provide a direct memory access control device and method for automatically updating a data transmission size without having intervention of a processor, when a DMA request is received from a peripheral.

It is another advantage of the present invention to provide a direct memory access controller compatible with AMBA (Advanced Micro-controller Bus Architecture) protocol.

In one aspect of the present invention, a direct memory access controller comprises a channel status generator determining whether the state of a channel connected to a peripheral corresponds to the first part of transmission data when a DMA request is received from the peripheral; an address generator generating addresses of the peripheral and a memory to which the data will be transmitted; a control signal generator generating signals that represent DMA operation states; and a buffer temporarily storing data transmitted from the peripheral and then transmitting the data to the memory. The address generator generates an address of a register storing a data transmission size of the peripheral when the channel state represents the first part of the data, and the control signal generator generates a control signal for receiving a value stored in the register storing the data transmission size, to thereby automatically update the data transmission size of the peripheral.

The direct memory access controller further comprises a host interface that is connected to the channel and receives/outputs the data and control signal from/to the peripheral; a channel selector selecting a channel through which the DMA operation will be carried out when the DMA request is received from at least two peripherals; and a ready generator generating a ready signal that represents whether the transmission of the data is completed.

The host interface includes a first register representing whether the peripheral requests the direct memory access controller to update the data transmission size, and a second register storing the address value of the transmission size register of the peripheral.

The host interface further includes a third register storing the address of the peripheral that transmits the data, a fourth register storing information on the type of the transmitted data, a fifth register storing the data transmission size, a sixth register storing the address of a destination to which the data will be transmitted, a seventh register storing information on the type of the data transmitted to the destination, and an eighth register storing the size of the data transmitted to the destination.

The channel is formed in AMBA (Advanced Micro-controller Bus Architecture).

The control signal generator generates the signals representing the DMA operation states such that the signals conform to an AMBA protocol.

In another aspect of the present invention, a memory access control method comprises determining whether a DMA request is received from a peripheral; determining whether the peripheral requests a DMAC to update a data transmission size when the DMA request is received from the peripheral; detecting the data transmission size from the peripheral when the peripheral requests the DMAC to update the data transmission size; and carrying out a DMA operation on the basis of the detected data transmission size.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 illustrates a system according to an embodiment of the present invention;

FIG. 2 illustrates the configuration of a DMAC according to an embodiment of the present invention;

FIG. 3 illustrates the configuration of a host interface of the DMAC according to an embodiment of the present invention;

FIG. 4 is a flow chart showing the operation of the DMAC according to an embodiment of the present invention;

FIG. 5 shows the operation of the DMAC according to an embodiment of the present invention;

FIG. 6 shows the operation of the DMAC according to an embodiment of the present invention when a peripheral generates new input data after the lapse of a predetermined time after the operation of FIG. 5 is carried out; and

FIG. 7 shows the operation of a conventional DMAC in the same environment as the environment of FIG. 6.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

To clarify the present invention, parts which are not described in the specification are omitted, and parts for which similar descriptions are provided have the same reference numerals.

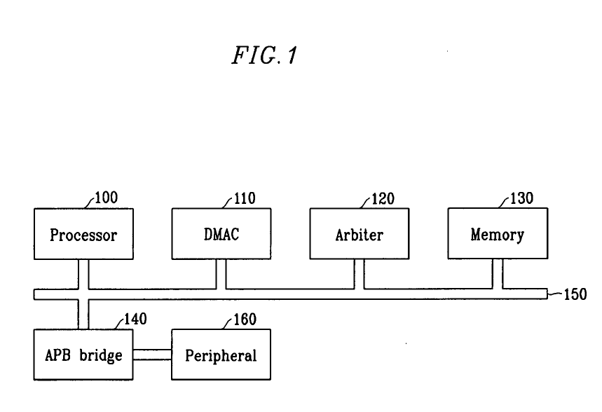

FIG. 1 illustrates a system according to an embodiment of the present invention. Referring to FIG. 1, the system includes a processor 100, a DMAC 110, an arbiter 120, a memory 130, an APB bridge 140, and an AMBA 150. A peripheral 160 is connected to the system via the APB bridge 140. The peripheral 160 transmits a DMA request to the DMAC 110 through the APB bridge 140. The DMAC 110 requests the arbiter 120 to allow the DMAC to be a bus master.

When the arbiter 120 authenticates the DMAC 110 and the DMAC 110 becomes the bus master, the DMAC 110 reads data from the peripheral 160, and then writes the data in the memory 130.

When the size of data transmitted from the peripheral 160 is changed, the DMAC 110 can update the data size without having intervention of the processor 100 or using a separate signal, which will be explained later.

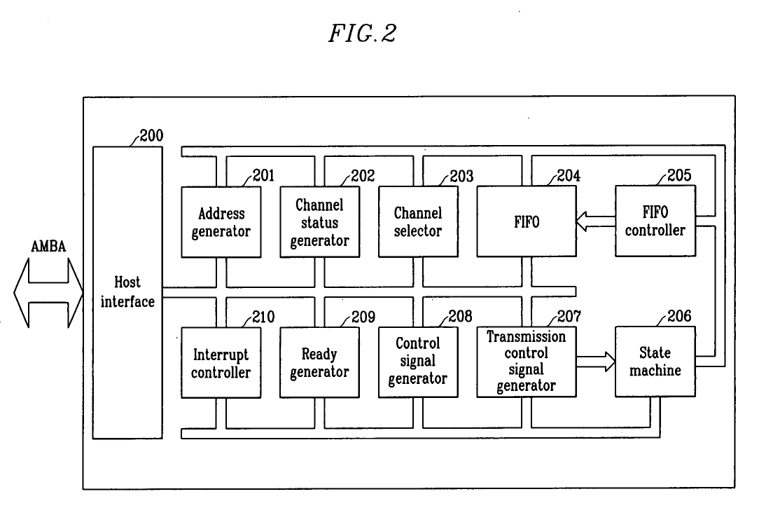

FIG. 2 illustrates the configuration of the DMAC 110 according to an embodiment of the present invention. Referring to FIG. 2, the DMAC 110 includes a host interface 200, an address generator 201, a channel status generator 202, a channel selector 203, a FIFO 204, a FIFO controller 205, a state machine 206, a transmission control signal generator 207, a control signal generator 208, a ready generator 209, and an interrupt controller 210.

The host interface 200 is directly connected to the AMBA 150 and receives/outputs data or control information from/to the processor 100 or selected peripheral 60. The address generator 201 generates a corresponding register address of the peripheral 160 in order to update data transmission size information when the DMAC 110 is operated as the master of the system. In addition, when data is transmitted between the peripheral 160 and the memory 130, the address generator 201 generates addresses of the peripheral 160 and the memory 130. Here, the generated addresses are of a fixed, increasing, or decreasing type depending on a control signal. According to an embodiment of the present invention, an increase/decrease can be set to one of 1, 2, and 4.

The channel status generator 202 receives the data transmission size information and state information of the state machine 106 to determine whether a current channel state represents the first part of the transmitted data. This is for the purpose of preventing the data transmission size information of the peripheral 160 from being repeatedly updated.

The channel selector 203 selects a channel through which the DMA operation will be carried out in consideration of priority of channels when a plurality of peripherals simultaneously generate DMA requests. The FIFO 204 is a buffer for temporarily storing input/output data. According to an embodiment of the present invention, the FIFO 204 has a capacity of 1 Kbyte corresponding to the maximum quantity of data that can be simultaneously processed by DMA.

The FIFO controller 205 receives the state information of the state machine 106 to generate a signal for controlling input/output of the FIFO 204 and generates point information. The state machine 206 receives control signals representing DMA operation states from the transmission control signal generator 207 to generate an index signal representing the current DMA operation state. The transmission control signal generator 207 generates READ START/COMPLETE and WRITE START/COMPLETE signals that represent DMA operation states and calculates a data transmission size using a counter.

The control signal generator 208 generates control signals compatible with the protocol of the AMBA 150 in response to the state information of the state machine 206. The ready generator 209 generates a ready signal that represents whether data transmission is completed or not. Here, the ready generator 209 generates the ready signal on the basis of the state information of the state machine 206.

The interrupt controller 210 transmits information about the completion of the DMA operation or information about whether the DMA operation has an error to the processor 100. The interrupt controller 210 generates an interrupt to transfer the authority of the DMAC 110 to serve as the master to the processor 100 such that the DMA operation can be normally carried out in the interrupted state.

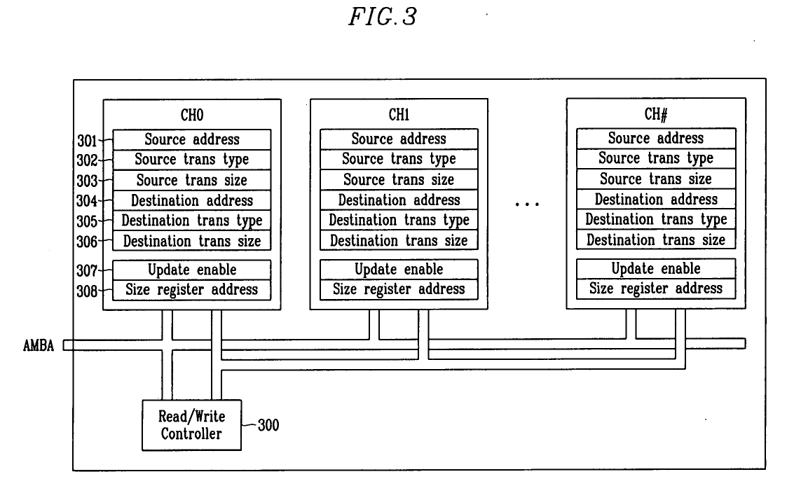

FIG. 3 illustrates the internal structure of the host interface 200 of the DMAC 110 according to an embodiment of the present invention. Referring to FIG. 3, the host interface includes a source address register 301, a source transmission type register 302, a source transmission size register 303, a destination address register 304, a destination transmission type register 305, a destination transmission size register 306, an update enable register 307, and a size register address register 308, for each channel.

The source address register 301 has the address of the peripheral 160 or memory 130 having transmission data. The source transmission type register 302 represents information on the type of data transmitted from a source (peripheral) to the DMAC 110. The type information conforms to the protocol of the AMBA 150 and has a value indicating the size of a single data item (8/16/32 bits) and data continuity. The value represents a non-transfer state of 32 bit data when initialized. The source transmission size register 303 represents the entire size of data to be transmitted through DMA and has a data transmission size value that is initially set to each channel.

The destination address register 304 has the address of the peripheral 160 or memory 130 that receives data. The destination transmission type register 305 stores information on the type of data transmitted to a destination. The value stored in the destination transmission type register 305 is identical to the value stored in the source transmission type register 302. The destination transmission size register 306 represents the entire size of the data transmitted to the destination.

The update enable register 307 represents whether the peripheral 160 or memory 130 requests the DMAC to update a data transmission size. The size register address register 308 has a register address value of the peripheral 160 or memory 130 that stores the data transmission size value when there is a request from the update enable register 307.

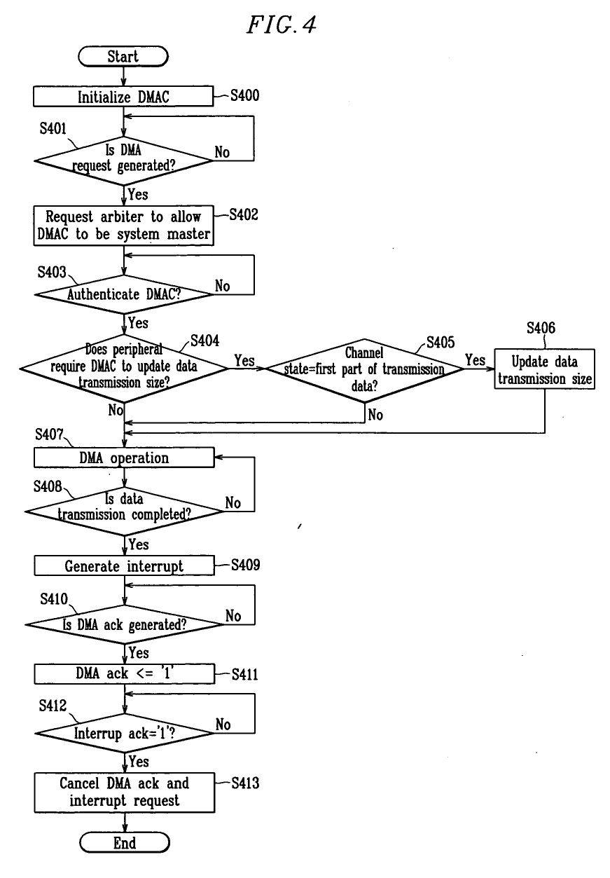

The operation of the DMAC 110 according to an embodiment of the present invention will now be explained. FIG. 4 is a flow chart showing the operation of the DMAC 110.

When the DMAC 110 is initialized, values of the internal registers 301 through 308 of the host interface 200 are initialized in step S400. In step S401, it is determined whether the DMAC 110 is requested to carry out the DMA operation while the system is normally operated. When the DMAC 110 is requested, the DMAC 110 outputs a request signal to the arbiter 120 in order to be a master of the system in step S402. Then, it is determined whether the DMAC 110 is authorized to be the master of the system and the DMAC 110 is in a stand-by state until it becomes the master in step S403.

When the DMAC 110 becomes the master, the DMAC 110 determines whether the peripheral 160, which has transmitted a request signal to the DMAC 110, requests the DMAC to update a data transmission size in step S404. When the DMAC 110 determines that the peripheral does, the channel status generator 202 determines whether the current state of a corresponding channel represents the first part of the entire transmission data in step S405. Only when the data is firstly transmitted can a normal operation be carried out when a data transmission size value is received from a corresponding peripheral.

When the current state of the corresponding channel represents the first part of the transmission data, the DMAC 110 receives a data transmission size from the transmission size register of the corresponding channel in step S406. Specifically, the address generator 201 of the DMAC 110 generates an address of a transmission size register of the peripheral 160, and the transmission control signal generator 207 of the DMAC 110 generates data type information of a size value that will be received by the DAMC 110. Furthermore, the control signal generator 208 of the DMAC 110 generates a read signal indicating that the DMAC 110 receives the size value. The control signals generated as above select the corresponding peripheral 160 according to the AMBA protocol and transfer the transmission size register value of the peripheral to the DMAC 110.

Then, the DMA operation is carried out on the basis of the updated transmission data size information in step S407. The DMA operation will be explained later.

While the DMAC 110 is operated, the ready generator 209 monitors the value of the state machine 206 and becomes aware of current state information in step S408. In addition, the ready generator 209 generates an interrupt signal when the state information output from the state machine 206 indicates the completion of data transmission, to thereby inform a user that the operation of the DMAC 110 is finished in step S409.

When the processor 100 receives the interrupt signal from the DMAC 110, the processor 100 carries out a DMAC interrupt handling operation in step S410 and generates an ACK signal to cancel the DMA request signal of the peripheral 160 in step S411.

While the interrupt operation is executed, the DMAC 110 generates a DMA_ACK signal to the peripheral 160 that has sent the DMA request signal to cancel the request signal in step S412, and cancels an interrupt request signal of the DMAC 110 using the interrupt ACK signal generated by the processor 100, finishing the operation thereof in step S413.

Through the aforementioned routine, the DMAC 110 can update the transmission data size information without having intervention of the processor 100 or using a separate signal.

The MAC operation after the peripheral receives the transmission data size information will now be explained.

The address generator 201 of the DMAC 110 generates an address value of the peripheral 160 and stores it in the source address register 301 of the host interface 100. The transmission control signal generator 207 generates a read signal.

Then, the transmission control signal generator 207 of the DMAC 110 generates data type information that represents the number of transmission data bits or data continuity and stores the type information in the source transmission type register 302. The APB bridge 140 that connects the DMAC 110 to the peripheral 160 conforms address information of the transmitted data, control signals, and data signals to characteristics of the ABMA bus.

Then, the peripheral 160 transmits data to the DMAC 110, and the FIFO 104 of the DMAC 110 stores the data. Subsequently, the address generator 201 generates an address of the memory 130 in which the data will be stored and records the address in the destination address register 304.

The transmission control signal generator 207 generates a write signal and creates transmission data type information signal to store it in the destination transmission type register 205. The APB bridge 140 connecting the DMAC 110 to the peripheral 160 conforms data address information, control signals, and data signals to characteristics of the AMBA bus and transmits data from the DMAC 110 to a destination. By doing so, the write operation is finished and the interrupt controller 210 of the DMAC 110 generates an operation completion interrupt.

The operation of the DMAC 110 according to an embodiment of the present invention will now be explained in comparison with the operation of a conventional DMAC.

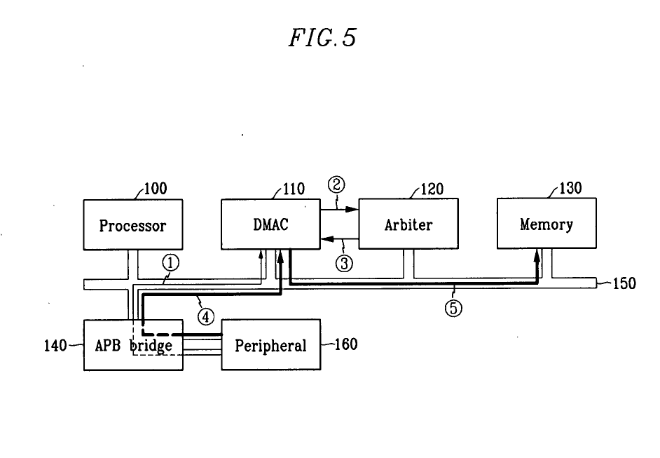

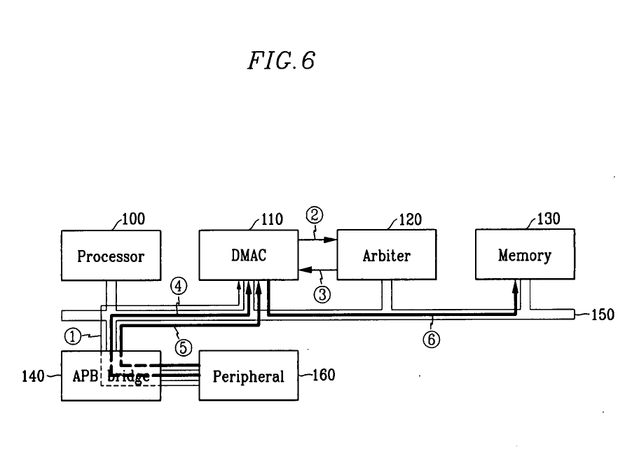

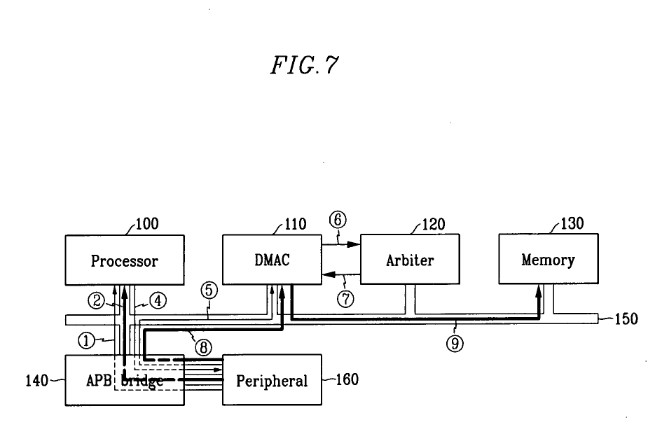

FIGS. 5 and 6 show examples of the operation of the DMAC 110 according to an embodiment of the present invention, and FIG. 7 shows an example of the operation of the conventional DMAC.

First of all, it is assumed that values stored in the registers of the DMAC 110 in the initial state of the system are as follows.
Update enable register 307: ENABLE
Size register address register 308: 0x40001008
Channel status generator 202: IDLE
Channel counter base value: 20
Channel counter: 20

Here, the value stored in the size register address register 308 means the quantity of data transmitted from the peripheral 160. Furthermore, the channel counter base value means a count of DMA bursts in the peripheral 160, and the channel counter represents the remaining burst count.

FIG. 5 shows the operation of the system when the peripheral 160 generates a DMA request signal.

Referring to FIG. 5, when the peripheral 160 generates a DMA request signal to the DMAC 110 \mathring{1}, the DMAC 110 requests the arbiter 120 to allow the DMAC to be a bus master \mathring{2}. Then, the arbiter 120 authenticates the DMAC 110 \mathring{3}, and an operation of reading data from the peripheral 160 to the FIFO 204 is carried out twenty times \mathring{4}. When the data reading operations are finished, the DMAC 110 writes the read data in the memory 130 \mathring{5}. When the writing operation is finished, the operation of the DMAC 110 is completed.

After the execution of the process shown in FIG. 5, values stored in the registers of the DMAC 110 as follows.
Update enable register 307: ENABLE
Size register address register 308: 0x40001008
Channel status generator 202: IDLE (\mathring{1} \mathring{2} \mathring{3} \mathring{6}), RUN (\mathring{4} \mathring{5})
Channel counter base value: 20
Channel counter: decreased from the channel counter base value by −1 in the operation \mathring{4} and, when the operation \mathring{5} is started, increased to 20 and then decreased by −1

FIG. 6 shows the operation of the system when the peripheral 160 generates new input data with a size increased to 40.

When the peripheral 160 generates a MAC request signal to the DMAC 110 \mathring{1}, the DMAC 110 requests the arbiter 120 to allow the DMAC to be a bus master of the system \mathring{2}. Then, the arbiter 120 authenticates the DMAC 110 \mathring{3}. The peripheral 160 transmits a transmission data size to the DMAC 110 \mathring{4}, and the DMAC 110 records the transmission data size in the size register address register 308. After forty operations of reading data from the peripheral 160 to the FIFO 204 of the DMAC 1100 \mathring{5} are carried out, the DMAC 110 writes the data stored in the FIFO 204 to the memory 140 \mathring{6}.

Values stored in the registers of the DMAC 110 after the execution of the process shown in FIG. 6 are as follows.
Update enable register 307: ENABLE
Size register address register 308: 0x40001008
Channel status generator 202: IDLE (\mathring{1} \mathring{2} \mathring{3} \mathring{4}\mathring{7}), RUN (\mathring{5} \mathring{6})
Channel counter base value: 40 (updated)
Channel counter: decreased from the channel counter base value by −1 in the operation \mathring{5} and, when the operation \mathring{6} is started, increased to 40 and then decreased by −1.

FIG. 7 shows the operation of the conventional DMAC in the same environment of the environment where the DMAC according to the present invention is operated, shown in FIG. 6.

Referring to FIG. 7, the peripheral 160 transmits an interrupt signal to the processor 100 in order to change the channel counter base value of the DMAC 110 \mathring{1}, and inputs a burst count value to the processor 100 \mathring{2}. Then, the processor 100 updates a burst count base value of the DMAC 110 \mathring{3}, and outputs a DMA request enable signal to the peripheral 160 and then cancels the interrupt signal \mathring{4}.

When the peripheral 160 requests the DMAC 110 to carry out the DMA operation \mathring{5}, the DMAC 110 requests the arbiter 120 to allow the DMAC to be the bus master of the system \mathring{6}. Then, the arbiter authenticates the DMAC 110 \mathring{7}. When the DMAC 110 becomes the bus master, it carries out forty operations of reading data from the peripheral 160 \mathring{8}. Subsequently, an operation of writing data from the FIFO of the DMAC 110 to the memory 130 is performed \mathring{9}, and the operation of the DMAC 110 is completed.

In a prior art, as described above, the peripheral 160 makes a request for interrupt in order to change the channel counter base value of the DMAC 110 and inputs the burst count value to the processor 100 in order to update the burst count base value of the DMAC 110 by the processor 100. That is, the peripheral 160 should generate a separate output signal for a changed data size, and the processor 100 intervenes in the operation of changing the burst count base value of the DMAC 110. This increases system operating time and deteriorates system efficiency. However, the DMAC 110 according to the present invention can maximize the system efficiency by automatically updating a data size.

As described above, the DMAC of the present invention can construct a system efficiently operated in view of operating time. Furthermore, the DMAC of the present invention includes the register 207 capable of determining whether updating of a transmission data size is required or not, and the register 208 storing an address value of a register having a data size of the peripheral so that the transmission data size of the peripheral can be automatically updated.

The present invention can further include a device that allows the DMAC to receive a data transmission size from the peripheral only when data is initially transmitted, but makes the DMAC not access the peripheral in other cases when the DMAC is requested to process data having a size exceeding 1 Kbyte that is the maximum transmission capacity of the DMAC.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A direct memory access controller comprising:
a channel status generator determining whether the state of a channel connected to a peripheral corresponds to the first part of transmission data when a DMA request is received from the peripheral;
an address generator generating addresses of the peripheral and a memory to which the data will be transmitted;
a control signal generator generating signals that represent DMA operation states; and
a buffer temporarily storing data transmitted from the peripheral and then transmitting the data to the memory,
wherein the address generator generates an address of a register storing a data transmission size of the peripheral when the channel state represents the first part of the data, and the control signal generator generates a control signal for receiving a value stored in the register storing the data transmission size, to thereby automatically update the data transmission size of the peripheral.

2. The direct memory access controller as claimed in claim 1, further comprising:
a host interface that is connected to the channel and receives/outputs the data and control signal from/to the peripheral;
a channel selector selecting a channel through which the DMA operation will be carried out when the DMA request is received from at least two peripherals; and
a ready generator generating a ready signal that represents whether the transmission of the data is completed.

3. The direct memory access controller as claimed in claim 2, wherein the host interface includes a first register representing whether the peripheral requests the direct memory access controller to update the data transmission size, and a second register storing the address value of the transmission size register of the peripheral.

4. The direct memory access controller as claimed in claim 3, wherein the host interface further includes a third register storing the address of the peripheral that transmits the data, a fourth register storing information on the type of the transmitted data, a fifth register storing the data transmission size, a sixth register storing the address of a destination to which the data will be transmitted, a seventh register storing information on the type of the data transmitted to the destination, and an eighth register storing the size of the data transmitted to the destination.

5. The direct memory access controller as claimed in claim 1, wherein the channel is formed in AMBA (Advanced Micro-controller Bus Architecture).

6. The direct memory access controller as claimed in claim 5, wherein the control signal generator generates the signals representing the DMA operation states such that the signals conform to an AMBA protocol.

7. A direct memory access control method comprising:
determining whether a DMA request is received from a peripheral;
determining whether the peripheral requests a DMAC to update a data transmission size when the DMA request is received from the peripheral;
detecting the data transmission size from the peripheral when the peripheral requests the DMAC to update the data transmission size; and
carrying out a DMA operation on the basis of the detected data transmission size.

8. The direct memory access control method as claimed in claim 7, wherein the detecting the data transmission size from the peripheral comprises:
determining whether the state of a channel connected to the peripheral represents the first part of the data; and
detecting the data transmission size from the peripheral when the channel state represents the first part of the data.

9. The direct memory access control method as claimed in claim 8, wherein the detecting the data transmission size from the peripheral generates an address of a register storing the data transmission size of the peripheral, data type information of a value stored in the address, and a read signal for receiving a value stored in the register, and transmits them to the peripheral, to thereby detect the data transmission size.

10. The direct memory access control method as claimed in claim 7, wherein the channel is formed in AMBA, and the peripheral transmits the data via an APB bridge.

11. The direct memory access control method as claimed in claim 7, wherein the carrying out a DMA operation on the basis of the detected data transmission size comprises:
generating an address value of the peripheral and a read signal;
receiving the data from the peripheral and storing it;
generating an address value of a memory in which the data will be stored and a write signal; and
transmitting the data to the memory.

12. The direct memory access control method as claimed in claim 7, further comprising, before the determining whether the peripheral requests the DMAC to update a data transmission size, requesting an arbiter to allow the DMAC to be a master of the channel, and the arbiter authenticating the DMAC to determine the master of the channel.
